(19) United States
(12) Patent Application Publication
(10) Pub. No.: US 2008/0156360 A1
(43) Pub. Date: Jul. 3, 2008

(54) HORIZONTAL MEGASONIC MODULE FOR CLEANING SUBSTRATES

(75) Inventors: Donald J.K. Olgado, Palo Alto, CA (US); Sheshraj L. Tulshibagwale, Santa Clara, CA (US); Thomas B. Brezoczky, San Jose, CA (US); John S. Lewis, Sunnyvale, CA (US); Ho Seon Shin, Cupertino, CA (US); Hui Chen, Burlingame, CA (US); Roy C. Nangoy, Santa Clara, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC.

(21) Appl. No.: 11/961,587

(22) Filed: Dec. 20, 2007

Related U.S. Application Data
(60) Provisional application No. 60/871,914, filed on Dec. 26, 2006.

(51) Int. Cl. B08B 3/00

(52) U.S. Cl. 134/140; 134/147

(57) ABSTRACT

Embodiments of the present invention relate to semiconductor device manufacturing, and more particularly to a horizontal megasonic module for cleaning substrates. In one embodiment an apparatus for cleaning a substrate is provided. The apparatus comprises a tank adapted to contain a cleaning fluid, a movable housing having a first side adapted to be placed in the cleaning fluid, a plurality of rotatable rollers coupled to the first side of the housing, the rollers positioned and including grooves to securely hold the substrate in a horizontal orientation, and one or more transducers adapted to direct vibrational energy through the cleaning fluid in the tank toward the substrate, wherein at least one of the transducers directs vibrational energy toward the substrate and substantially parallel to a major surface of the substrate.

### CROSS-REFERENCE TO RELATED APPLICATIONS

This application claims benefit of U.S. provisional patent application Ser. No. 60/871,914, filed Dec. 26, 2006, which is herein incorporated by reference.

### BACKGROUND OF THE INVENTION

1. Field of the Invention

Embodiments of the present invention relate to semiconductor device manufacturing, and more particularly to a horizontal megasonic module for cleaning substrates.

2. Description of the Related Art

In certain industries there are processes that must be used to bring objects to an extraordinarily high level of cleanliness. For example, in the fabrication of semiconductor substrates, multiple cleaning steps, known as surface preparation, are typically required to remove impurities from the surfaces of the substrates before subsequent processing. A typical surface preparation procedure may include etch, clean, rinse and dry steps. An etch step may involve immersing the substrates in an etch solution of HF to remove surface oxidation and metallic impurities and then thoroughly rinsing the substrates in high purity deionized water (DI) to remove etch chemicals from the substrates. During a typical cleaning step, the substrates are exposed to a cleaning solution that may include water, ammonia or hydrochloric acid, and hydrogen peroxide. After cleaning, the substrates are rinsed using ultra-pure water and then dried using one of several known drying processes. The effectiveness of a substrate fabrication process is often measured by two related and important factors, which are device yield and the cost of ownership (CoO). These factors are important since they directly affect the cost to produce an electronic device and thus a device manufacturer's competitiveness in the market place. The CoO, while affected by a number of factors, is greatly affected by the system and chamber throughput, or simply the number of substrates per hour processed using a desired processing sequence. In an effort to reduce CoO, electronic device manufacturers often spend a large amount of time trying to optimize the process sequence and chamber processing time to achieve the greatest substrate throughput possible given the tool architecture limitations and the chamber processing times.

For the foregoing reasons, there is a need for a tool that can meet the required device performance goals, has a high substrate throughput, and thus reduces the process sequence CoO.

### SUMMARY OF THE INVENTION

Embodiments of the present invention relate to semiconductor device manufacturing, and more particularly to a horizontal megasonic module for cleaning substrates. In one embodiment an apparatus for cleaning a substrate is provided. The apparatus comprises a tank adapted to contain a cleaning fluid, a movable housing having a first side adapted to be placed in the cleaning fluid, a plurality of rotatable rollers coupled to the first side of the housing, the rollers positioned and including grooves to securely hold the substrate in a horizontal orientation, and one or more transducers adapted to direct vibrational energy through the cleaning fluid in the tank toward the substrate, wherein at least one of the transducers directs vibrational energy toward the substrate and substantially parallel to a major surface of the substrate.

In another embodiment an apparatus for cleaning multiple substrates is provided. The apparatus comprises a tank adapted to contain a cleaning fluid, a first movable housing having a first side adapted to be placed into the cleaning fluid, a first plurality of rotatable rollers coupled to the first side of the first housing, the rollers positioned and including grooves to securely hold a first substrate in a horizontal orientation, a second movable housing having a first side adapted to be placed into the cleaning fluid, a second plurality of rotatable rollers coupled to the first side of the second housing, the rollers positioned and including grooves to securely hold a first substrate in a horizontal orientation, and a first transducer positioned between the first housing and the second housing, wherein the first transducer is adapted to generate vibrations that may propagate horizontally toward both housings and the substrates held therein.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic cross-sectional view of a horizontal megasonic module provided in accordance with one embodiment of the present invention; and

FIG. 2 is a schematic cross-sectional view of a multiple-substrate horizontal megasonic module in accordance with one embodiment of the present invention.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

In semiconductor device processing, chemical-mechanical polishing (CMP) processes are typically followed by one or more cleaning procedures in which loose substrate particles and slurry resulting from the polishing process are removed from the surface of a substrate. One of the conventional techniques for cleaning substrates is megasonic cleaning, in which a substrate is submerged in a fluid bath and subjected to megasonic frequency vibrations (500 kHz or greater) which dislodge the particles and/or slurry residue from the substrate surfaces.

Embodiments of the present invention provide an apparatus or module for horizontal megasonic substrate cleaning in which a substrate may be subjected to megasonic vibrations while positioned in a horizontal orientation. One or more transducers may generate megasonic vibrations directed substantially parallel to the major surface(s) of a horizontally oriented substrate. The present invention also provides an apparatus or module in which multiple horizontally oriented substrates may be subjected to megasonic vibrations.

One of the advantages of a horizontal megasonic module in comparison with a vertically-oriented module is that a horizontal megasonic module may be able to more evenly distribute vibrational energy across the surface of a substrate. The improved energy distribution enables a lower wattage to be applied; the lower wattage, in turn, reduces wear on rollers and other components of the module. Control of the grip on a substrate (e.g., by rollers) also may be improved.

Additionally, transfer of a substrate into or out of a horizontal module is generally more stable and efficient because the substrate is held (in part) by gravity against the transferring device (such as a robot). Because other polishing and/or cleaning modules may process substrates horizontally, a single robot can generally serve all of the modules of a polishing and cleaning system. Further advantages are discussed in conjunction with the following description of embodiments of the present invention.

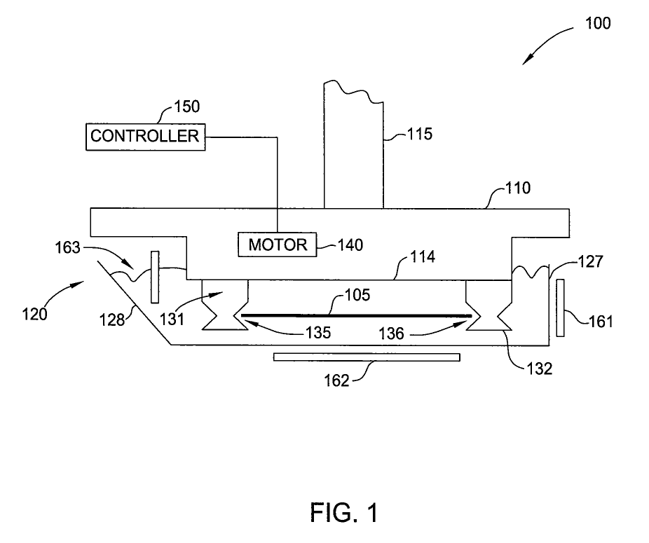

FIG. 1 is a schematic cross-sectional view of a horizontal megasonic module 100 provided in accordance with the present invention. As shown, the module 100 comprises a generally horizontally extending housing 110 supported above by a shaft member 115. During a cleaning operation, as shown, the housing 110 may be submerged in a cleaning fluid contained in a tank 120. The cleaning fluid may comprise deionized water (DIW), a cleaning chemistry (SCI), surfactants, acids, bases and/or any other suitable cleaning solution. The tank 120 may be made of any material compatible with the cleaning fluid.

Rollers 131, 132 are coupled to and extend from a lower edge 114 of the housing 110. While only two rollers 131, 132 are shown in the cross-sectional view of FIG. 1, in some embodiments the module 100 may include three rollers spaced 120 degrees apart in the horizontal plane (e.g., to securely support a substrate). A greater number of rollers, such as four rollers, may also be used.

A motor 140, which may be disposed in the housing or in any other suitable location, is operatively coupled to one or both of the rollers 131, 132 such that the rollers can rotate. In some embodiments, a separate drive mechanism may be included for each roller. In other embodiments, only a single roller may be driven and the remaining rollers may rotate passively.

Each of the rollers 131, 132 include a groove 135, 136 which can be V-shaped as shown or may be otherwise shaped, such as U-shaped. The rollers 131, 132 may be positioned on the housing 110 so as to surround a substrate 105 of a particular diameter in a horizontal orientation.

In some embodiments, the motor 140 or another motor (not shown) may move one or more of the rollers 131, 132 a small distance horizontally to position the rollers 131, 132 in or out of gripping contact with the substrate 105 for receiving or releasing the substrate 105. When in gripping contact, the rollers 131, 132 exert sufficient force on the edge of the substrate 105 to firmly secure the substrate 105 in place within the grooves 135, 136 while allowing the substrate 105 to rotate with the rotation of the rollers 131, 132.

A controller 150 may be coupled to the motor 140 and control the motion and/or rotation of the rollers 131, 132 and/or the raising and/or lowering of the housing 110. The controller 150 may also receive signals from a rotation sensor (not shown) that monitors the rotation of the rollers 131, 132, and provides an indication of the rotational speed of the substrate 105. For example, one or more of the rollers 131, 132 may include a magnet (not shown), and the rotation of the magnet may be used to indicate roller and substrate rotation rate.

One or more transducers 161, 162, 163 may be positioned within or on the outside of the tank 120 to generate vibrational energy within the fluid of the tank 120 at a megasonic or other frequency. The transducers 161, 162, 163 may be implemented, for example, using piezoelectric actuators, or any other suitable mechanism that can generate vibrations at megasonic frequencies of suitable amplitude. While three transducers are shown in FIG. 1, fewer or a larger number of transducers may be used. The embodiment depicted shows advantageous configurations where transducers may be placed to direct vibrational energy effectively toward the substrate 105.

A first transducer 161 may be directly coupled to or positioned adjacent to an external surface of a first side 127 of the tank 120. The first transducer 161 is oriented to generate vibrational energy that travels through the tank 120 and cleaning fluid to impact the substrate 105 from the side, substantially parallel to the major surface(s) of the substrate 105. In some embodiments, the vibrational energy is directed at an angle of about 10 degrees or less from a plane defined by the major surface(s) of the substrate 105 and/or within about 10 degrees of horizontal. When vibrational energy is directed substantially parallel to the substrate's major surface(s), the vibrational wave fronts stream along the upper and lower surfaces of the substrate, impacting particles along their path.

A second transducer 162 may be directly coupled or positioned externally adjacent to the bottom of the tank 120 and may be oriented to generate vibrational energy that travels via the tank 120 and cleaning fluid to impact the bottom major substrate surface from below, approximately perpendicular to the substrate surface. In some embodiments, the second transducer 162 may have a surface area approximately the same size as (or larger than) the surface area of the substrate 105 in order to generate vibrational energy that encompasses the entire surface area of the substrate 105.

A third transducer 163 may be positioned adjacent to a second side 128 of and/or inside the tank 120, wholly or partially submerged in the cleaning fluid. The third transducer 163, like the first transducer 161, may be oriented to generate vibrational energy which impacts the substrate 105 from the side, substantially parallel to the major surface(s) of the substrate, e.g., within about 10 degrees of the major surface(s) of the substrate and/or horizontal. However, unlike the first transducer 163, the third transducer 163 may be in contact with the cleaning fluid and may transmit vibrational energy through the fluid directly.

It is noted that the transducers 161, 162, 163 may be placed in other suitable locations. Additionally, all three transducers need not be used together. For example, the first transducer 161 may be used alone, or one or both of the second and third transducers 162, 163 may be used without the first transducer 161. As in these example embodiments, it may be useful to have at least one transducer that provides vibrational energy substantially parallel to the major surface(s) of the substrate 105. The controller 150 may be adapted to control operation of the transducer 161, 162 and/or 163. Each transducer may provide energy continuously, periodically or at any suitable cycle time.

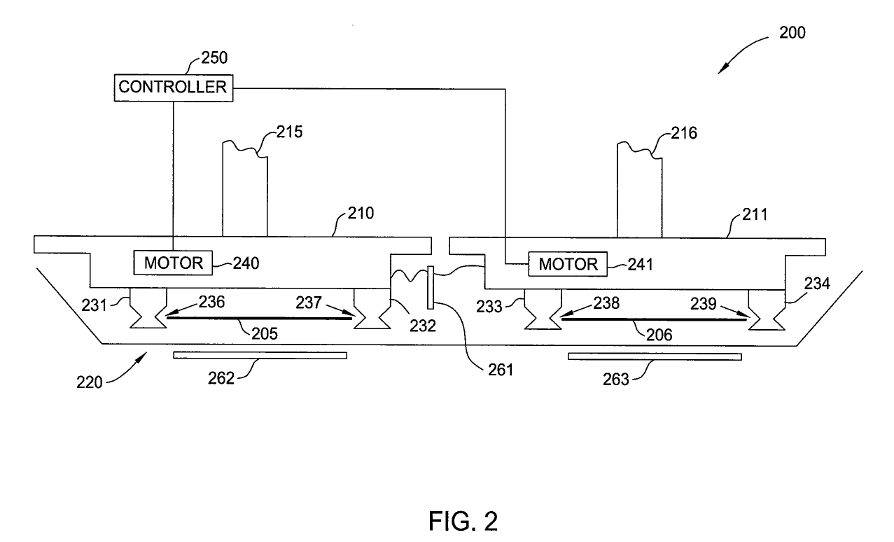

FIG. 2 is a schematic cross-sectional view of a multiple-substrate horizontal megasonic module 200 according to the present invention. The multiple-substrate module 200 can accommodate two (as shown) or more substrates simultaneously, increasing the throughput of the cleaning process. The module 200 includes separate housings 210, 211 for each substrate handled, which may be positioned adjacent to each other (as shown) or behind or in front of each other within a single tank 220 filled with cleaning fluid.

Each housing 210, 211 is supported from above by a respective shaft 215, 216 and supports, in turn, respective sets of rollers 231, 232 (first housing 210) and 233, 234 (second housing 211). Each housing 210, 211 may include one or more motors 240, 241. The motors 240, 241 may also be located at any other suitable location for driving the rollers 231, 232 and 233, 234 (e.g., each roller, a single roller in each set of rollers, etc.). In some embodiments, a single motor may be used to drive both sets of rollers and/or a single roller in each set (e.g., via gears, belts or the like). The respective sets of rollers 231, 232 and 233, 234 of the housings 210, 211 are positioned so as to each surround and support a substrate 205, 206 of a particular diameter and in a horizontal orientation. The rollers 231, 232 and 233, 234 include grooves 236, 237, 238 and 239 adapted to hold and secure the edge of a substrate 205, 206; the grooves 236, 237, 238, 239 may be V-shaped (as shown) or any other suitable shape.

A single controller 250 (as shown) or multiple controllers may be coupled to the motors 240, 241 and thereby control the motion and/or rotation of the rollers 231, 232, 233 and 234 and/or the raising and/or lowering of the housing 210, 211. The controller 250 may also receive signals from rotation sensors (not shown) that monitor the rotation of the rollers 231, 232, 233, 234 and/or the substrates 205, 206 (as previously described).

One of the advantageous features of the multiple-substrate module 200 is that vibrational energy produced by a transducer may be distributed over multiple substrates, which can reduce power needs and costs. For example, as shown in FIG. 2, a first transducer 261 may be positioned between the housings 210, 211 wholly or partially submerged within the cleaning fluid in the tank 220. Lateral back-and-forth movements of the transducer 261 generate vibrations that may propagate horizontally toward both housings 210, 211 and the substrates 205, 206 held therein.

As in the embodiment depicted in FIG. 1, additional or alternative transducers may be included that direct vibrational energy primarily perpendicularly onto the substrates 205, 206. For example, a second transducer 262 may be positioned adjacent to the bottom of the tank 120 and oriented to generate vibrational energy that travels through the tank 220 and cleaning fluid to impact the bottom surface of substrate 205 from below, approximately perpendicular to the bottom major surface of the substrate 205. The second transducer 262 may have a size that is similar to the size of the substrate 205 in order to generate vibrational energy that encompasses the entire area of the substrate 205. Similarly, a third transducer 263 may be positioned adjacent to the bottom of the tank 120 and oriented to generate vibrational energy that travels through the tank 220 and cleaning fluid to impact the bottom major surface of the substrate 206 (e.g., approximately perpendicularly). Fewer or a larger number of transducers may be used. The controller 250 may be adapted to control operation of the transducers 261, 262, and/or 263. Each transducer may produce energy continuously, periodically or at any suitable cycle time.

### Exemplary Operation of the Horizontal Megasonic Module

The following describes the operation of a single horizontal megasonic module. However, the description applies equally to a multi-substrate module unless otherwise indicated.

In operation, according to some embodiments of the present invention, before mega sonic cleaning commences, a substrate is brought to the housing 110 by a transfer device (not shown) such as a robot. The housing 110 at this point may be positioned above the tank 120, out of contact with the cleaning fluid. To receive a substrate, the motor 140 or another mechanism moves one or more of the rollers 131, 132 horizontally outward into a receiving position, and the robot moves the substrate between the rollers 131, 132 and at the level of the grooves 135, 136. The motor 140 or other mechanism then moves the previously-moved roller(s) back into a gripping position (FIG. 1). Enough force is applied by the rollers 131, 132 to secure the substrate in place and for the rollers 131, 132 to be in frictional contact with the edge of the substrate. The robot then releases the substrate and moves out of the module 100.

With the substrate in place, the housing 110 is lowered via the shaft 115 into the tank 120. In some embodiments, the housing 110 may descend into the tank 120 at a tilt to avoid air being trapped beneath the housing 110, which could lead to bubble formation. The tilt may be at or around 10 degrees from horizontal, for example, although larger or smaller tilt angles may be used. The housing 110 may be lowered until at least the substrate is completely submerged in the cleaning fluid and preferably until the rollers 131, 132 are completely submerged as well. The housing 110 may remain tilted or be returned to an approximately horizontal orientation.

Once submerged, the motor 140 may start the rotation of one or more of the rollers 131, 132 which, in turn, cause rotation of the substrate by frictional contact. The transducer(s) 161, 162 and/or 163 are activated to direct and transmit vibrational energy through the fluid to the substrate. In some embodiments, at least one of the transducers may direct vibrational energy substantially parallel to the major surface(s) of the substrate. In various embodiments and configurations, additional transducers may be used, one or more of which may direct vibrational energy perpendicularly with respect to the major surface(s) of the substrate. The vibrational energy unsettles and/or dislodges particles from substrate surfaces. Due to the rotation of the substrate, the vibrational energy is distributed over the substrate surface, which improves the efficiency and accuracy of the cleaning.

Fresh cleaning fluid may be continuously, periodically or otherwise supplied from a conduit (not shown) which may force used cleaning fluid to overflow the tank 120. The overflow may be captured by a reservoir (not shown) and either recycled or disposed of downstream.

Operation of the multi-substrate horizontal megasonic module 200 may be similar to that of the single substrate module 100 described above. A first substrate may be cleaned using the first housing 210 while a second substrate may be cleaned using the second housing 211 at the same time, at a different time, independently of or in coordination with the first substrate.

Accordingly, while the present invention has been disclosed in connection with specific embodiments thereof, it should be understood that other embodiments may fall within the spirit and scope of the invention, as defined by the following claims.

1. An apparatus for cleaning a substrate comprising:
a tank adapted to contain a cleaning fluid;
a movable housing having a first side adapted to be placed into the cleaning fluid;
a plurality of rotatable rollers coupled to the first side of the housing, the rollers positioned and including grooves to securely hold the substrate in a horizontal orientation; and
one or more transducers adapted to direct vibrational energy through the cleaning fluid in the tank toward the substrate;
wherein at least one of the transducers directs vibrational energy toward the substrate and substantially parallel to a major surface of the substrate.

2. The apparatus of claim 1, wherein the rollers are coupled to and extend from a lower edge of the housing.

3. The apparatus of claim 1, wherein the plurality of rotatable rollers comprises three rollers.

4. The apparatus of claim 3, wherein the three rollers are spaced 120 degrees apart in a horizontal plane.

5. The apparatus of claim 1, wherein a separate drive mechanism is included for each roller.

6. The apparatus of claim 1, wherein a motor is operatively coupled to the plurality of rotabable rollers such that the rollers can rotate.

7. The apparatus of claim 6, wherein the motor may move the plurality of rotatable rollers a small distance horizontally to position the rollers in or out of gripping contact with the substrate.

8. The apparatus of claim 1, wherein at least one of the plurality of rollers includes a magnet for monitoring the rotational speed of the at least one of the plurality of rollers.

9. The apparatus of claim 1, wherein the one or more transducers comprises a first transducer coupled to or externally adjacent to an external surface of a first side of the tank.

10. The apparatus of claim 1, where the vibrational energy is directed at an angle of about 10 degrees or less from a plane defined by a the major surfaces of the substrate

11. The apparatus of claim 8, further comprising a second transducer coupled to or externally adjacent to a bottom of the tank.

12. The apparatus of claim 11, wherein the second transducer has a surface area approximately the same size as or greater than the surface area of the substrate.

13. The apparatus of claim 11, further comprising a third transducer coupled to a second side of the tank.

14. An apparatus for cleaning multiple substrates, comprising:
a tank adapted to contain a cleaning fluid;
a first movable housing having a first side adapted to be placed into the cleaning fluid;
a first plurality of rotatable rollers coupled to the first side of the first housing, the rollers positioned and including grooves to securely hold a first substrate in a horizontal orientation;
a second movable housing having a first side adapted to be placed into the cleaning fluid;
a second plurality of rotatable rollers coupled to the first side of the second housing, the rollers positioned and including grooves to securely hold a first substrate in a horizontal orientation; and
a first transducer positioned between the first housing and the second housing, wherein the first transducer is adapted to generate vibrations that may propagate horizontally toward both housings and the substrates held therein.

15. The apparatus of claim 14, further comprising a second transducer coupled to or externally adjacent to a bottom of the tank.

16. The apparatus of claim 15, wherein the second transducer is adapted to direct vibrational energy primarily perpendicularly toward a major surface of the first substrate.

17. The apparatus of claim 15, wherein the second transducer has a surface area approximately the same size as or greater than the surface area of the substrate.

18. The apparatus of claim 15, further comprising a third transducer coupled to or externally adjacent to the bottom of the tank.

19. The apparatus of claim 18, wherein the third transducer has a surface area approximately the same size as or greater than the surface area of the substrate.

20. The apparatus of claim 18, wherein the third transducer is adapted to direct vibrational energy primarily perpendicularly toward a major surface of the second substrate.
